(19) United States
(12) Patent Application Publication
(10) Pub. No.: US 2006/0136830 A1
(43) Pub. Date: Jun. 22, 2006

(54) System and user interface for creating and presenting forms

(76) Inventors: Aaron Emerson Martlage, Narberth, PA (US); Dirk Zimmermann, Philadelphia, PA (US); Claus Knapheide, Philadelphia, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/266,000

(22) Filed: Nov. 3, 2005

Related U.S. Application Data
(60) Provisional application No. 60/624,621, filed on Nov. 3, 2004.

(51) Int. Cl. G06Q 10/00

(52) U.S. Cl. 715/745; 378/162; 705/2; 715/506

(57) ABSTRACT

A user interface system provides an electronic form supporting simplified navigation using table driven values and decisions. A display processor provides a display image enabling a user to perform a hierarchically ordered selection of a first parameter and a second parameter from a set of parameters associated with the selected first parameter. A repository contains data, representing multiple data fields, for display in a form, and associates particular data fields with a particular form and a particular ordered selection of parameters. A form processor generates data, representing a particular form including particular data fields derived from the repository, and initiates generation of data representing a display image including the particular form, in response to user selection of the first and second parameters.

### CROSS-REFERENCE TO RELATED APPLICATIONS

The present application is a non-provisional application of provisional application having Ser. No. 60/624,621 filed by Aaron E. Martlage, et al. on Nov. 3, 2004.

### FIELD OF THE INVENTION

The present invention generally relates to computer information systems. More particularly, the present invention relates to a system and user interface for creating and presenting forms.

### BACKGROUND OF THE INVENTION

Computer information systems (“systems”) include computers that communicate with each other over a network, such as the Internet, and computers that manage information. For example, a healthcare enterprise uses the systems to manage healthcare information for patients in the form of reports or documentation. Documentation may be made and stored on paper or electronically.

Paper documentation uses predefined tabular templates enabling users to capture various pieces of information. The templates limit flexibility to act on variations within a decision tree process. With the templates, a user makes changes typically by scribbling out a notation, and entering a new value into a margin of the template. Disadvantages of paper documentation include the lack of data trending, especially when the user alters the values of the template. The user also may be entering the same data repeatedly in various templates on several different sheets of paper. Further, space is reserved on paper documents for potential information that may be never valued, thus presenting the user with extraneous and unnecessary information in order to cover possible value scenarios.

In some electronic documentation systems, a user values data by selecting cells in a tabular view which then opens other tabular views (e.g., a tabular pop-up), or by navigating a large, pre-defined tree structure to value the data of specific elements (e.g., in a data tree).

In other electronic documentation systems, a user has difficulty navigating three-dimensional (i.e., 3D) models in a two-dimensional (i.e., 2D) user interface. For example, in a tabular pop-up model, users need to continuously revalue X and Y coordinates of a table. The system starts by the user valuing the X and Y coordinates of the table, and the user clicking the appropriate cell to value. By clicking the appropriate cell, a new table is opened on top of the previous table where the user needs to again value the X and Y coordinates of the table. After the user has valued the cell, the user closes the popped-up table and returns to the original table. When the user selects a different cell to value, the system again pops-up a new table in which the user needs to value the X and Y coordinates of the table once again, even if they were the same values as the first popped-up table. This electronic documentation process is a time consuming and tedious method for a user to value data.

In an electronic tree documentation model, a user does not need to continuously revalue data, but instead needs to spend the majority of his time navigating through a tree structure searching for the correct values. The tree structure often has many duplicate values to represent possible scenarios and combinations. Duplicate values can make navigating the tree structure confusing to a user, because many branches in the tree structure may appear to a user to have the same or similar values. There is a big learning curve for a user to learn a tree structure, because the user needs to memorize locations of the values in the tree structure they are repeatedly valuing.

Accordingly, there is a need for a system and user interface for creating and presenting documentation that overcomes these and other disadvantages of the prior systems.

### SUMMARY OF THE INVENTION

A user interface system provides users with a simple electronic navigation method to easily choose multi-dimensional data that can value a multitude of combinations of data to generate an electronic form. A display processor provides a display image enabling a user to perform a hierarchically ordered selection of a first parameter and a second parameter from a set of parameters associated with the selected first parameter. A repository contains data, representing multiple data fields, for display in a form, and associates particular data fields with a particular form and a particular ordered selection of parameters. A form processor generates data, representing a particular form including particular data fields derived from the repository, and initiates generation of data representing a display image including the particular form, in response to user selection of the first and second parameters.

### BRIEF DESCRIPTION OF THE DRAWINGS

FIG. 1 illustrates user interface system, in accordance with invention principles.

FIGS. 2-6 illustrate various views of the same display image generated by the user interface system, as shown in FIG. 1, in accordance with invention principles.

### DETAILED DESCRIPTION OF THE PREFERRED EMBODIMENTS

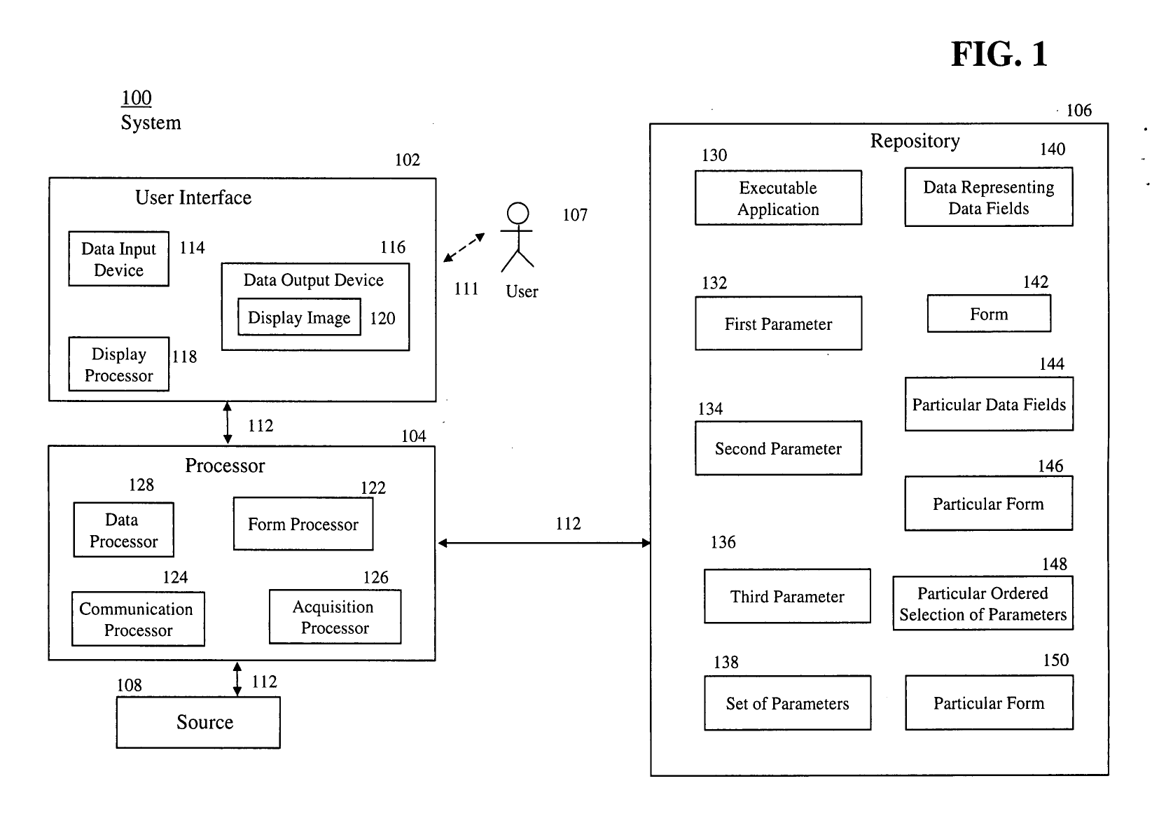

FIG. 1 illustrates user interface system, otherwise called a navigation grid user interface (NGUD system (i.e., “system”). The system 100 includes a user interface 102, a processor 104, and a repository 106. Each of a source 108 and a user 107 interfaces and/or interacts with the system 100.

A communication path 112 interconnects elements of the system 100, and/or interconnects the system 100 with the source 108. The dotted line near reference number 111 represents interaction between the user 107 and the user interface 102.

The user interface 102 further provides a data input device 114, a data output device 116, and a display processor 118. The data output device 116 further provides one or more display images 120.

The processor 104 further includes a form processor 122, a communication processor 124, an acquisition processor 126, and a data processor 128.

The repository 106 further includes an executable application 130, a first parameter 132, a second parameter 134, a third parameter 136, a set of parameters 138, data representing data fields 140, a form 142, a particular data fields 144, a particular form 146, particular ordered selection of parameters 148, and a particular form 150.

The system 100 may be employed by any type of enterprise, organization, or department, such as, for example, providers of healthcare products and/or services responsible for servicing the health and/or welfare of people in its care. For example, the system 100 represents a hospital information system. A healthcare provider provides services directed to the mental, emotional, or physical well being of a patient. Examples of healthcare providers include a hospital, a nursing home, an assisted living care arrangement, a home health care arrangement, a hospice arrangement, a critical care arrangement, a health care clinic, a physical therapy clinic, a chiropractic clinic, a medical supplier, a pharmacy, and a dental office. When servicing a person in its care, a healthcare provider diagnoses a condition or disease, and recommends a course of treatment to cure the condition, if such treatment exists, or provides preventative healthcare services. Examples of the people being serviced by a healthcare provider include a patient, a resident, a client, and an individual.

The system 100 may be fixed and/or mobile (i.e., portable), and may be implemented in a variety of forms including, but not limited to, one or more of the following: a personal computer (PC), a desktop computer, a laptop computer, a workstation, a minicomputer, a mainframe, a supercomputer, a network-based device, a personal digital assistant (PDA), a smart card, a cellular telephone, a pager, and a wristwatch. The system 100 and/or elements contained therein also may be implemented in a centralized or decentralized configuration. The system 100 may be implemented as a client-server, web-based, or stand-alone configuration. In the case of the client-server or web-based configurations, the executable application 130 may be accessed remotely over a communication network.

The communication path 112 (otherwise called network, bus, link, connection, channel, etc.) represents any type of protocol or data format including, but not limited to, one or more of the following: an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, a Campus Area Network (CAN) protocol, a Metropolitan Area Network (MAN) protocol, a Home Area Network (HAN) protocol, an Institute Of Electrical And Electronic Engineers (IEEE) bus compatible protocol, a Digital and Imaging Communications (DICOM) protocol, and a Health Level Seven (HL7) protocol.

The user interface 102 permits bi-directional exchange of data between the system 100 and the user 107 of the system 100 or another electronic device, such as a computer or an application.

The data input device 114 typically provides data to a processor in response to receiving input data either manually from a user or automatically from an electronic device, such as a computer. For manual input, the data input device is a keyboard and a mouse, but also may be a touch screen, or a microphone with a voice recognition application, for example.

The data output device 116 typically provides data from a processor for use by a user or an electronic device or application. For output to a user, the data output device 116 is a display, such as, a computer monitor (screen), that generates one or more display images in response to receiving the display signals from the display processor 118, but also may be a speaker or a printer, for example.

The display processor 118 or generator includes electronic circuitry or software or a combination of both for generating display images or portions thereof. The data output device 116, implemented as a display, is coupled to the display processor 118 and displays the generated display images. The display images permit user interaction with the processor 104 or other device. The display processor 118 may be implemented in the user interface 102 and/or the processor 104.

The system 100, elements, and/or processes contained therein may be implemented in hardware, software, or a combination of both, and may include one or more processors, such as processor 104. A processor is a device and/or set of machine-readable instructions for performing task. The processor includes any combination of hardware, firmware, and/or software. The processor acts upon stored and/or received information by computing, manipulating, analyzing, modifying, converting, or transmitting information for use by an executable application or procedure or an information device, and/or by routing the information to an output device. For example, the processor may use or include the capabilities of a controller or microprocessor.

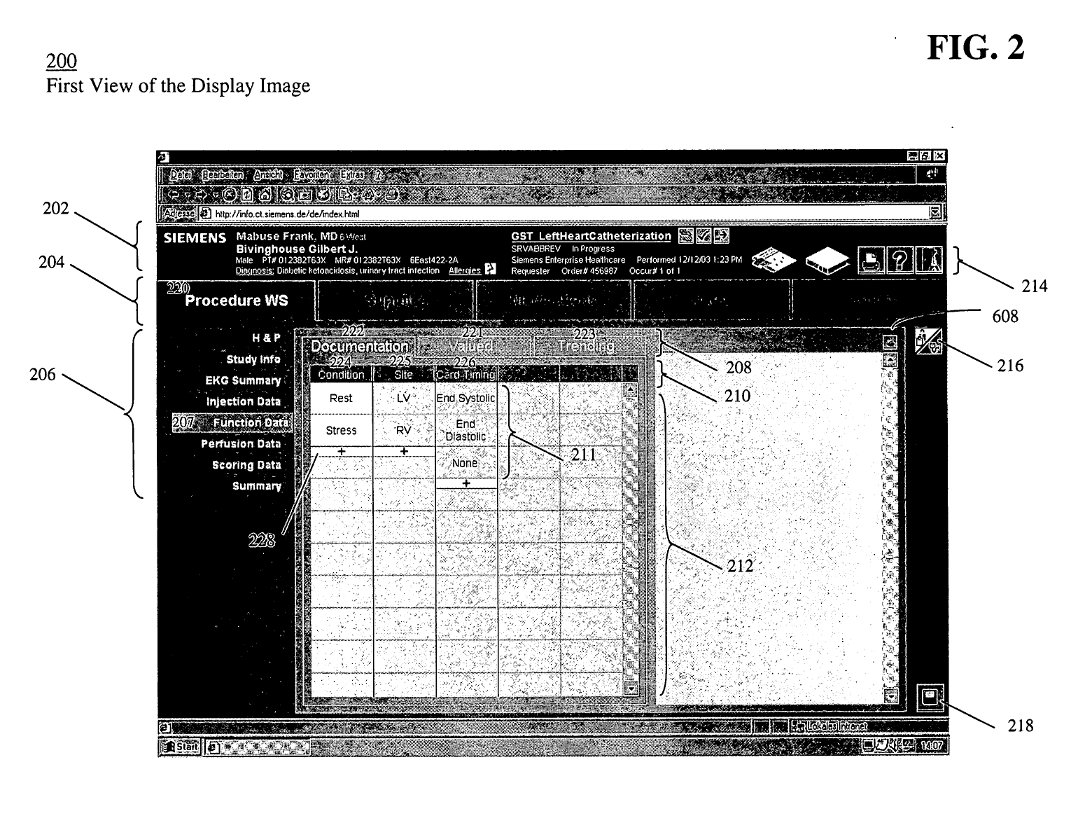

The form processor 122 performs specific functions for the system 100, as explained in further detail below, with reference to FIG. 1, and in further detail, with reference to FIGS. 2-6. The communication processor 124 manages communication within and outside the system 100. The acquisition processor 126 acquires any external information for the system 100, such as from the source 108. The data processor 128 performs other general and/or specific data processing for the system 100.

The repository 106 represents any type of storage device, such as computer memory devices or other tangible storage medium. The repository 106 represents one or more memory devices, located at one or more locations, and implemented as one or more technologies, depending on the particular implementation of the system 100.

An executable application, such as the executable application 130, comprises machine code or machine readable instruction for implementing predetermined functions including, for example, those of an operating system, a software application program, a healthcare information system, or other information processing system, for example, in response user command or input. An executable procedure is a segment of code (i.e., machine readable instruction), sub-routine, or other distinct section of code or portion of an executable application for performing one or more particular processes, and may include performing operations on received input parameters (or in response to received input parameters) and providing resulting output parameters. A calling procedure is a procedure for enabling execution of another procedure in response to a received command or instruction. An object comprises a grouping of data and/or executable instructions or an executable procedure.

The system 100 advantageously enables users to value a multidimensional set of data using a simple 2D interface that would normally require a 3D model. Complex decisions are streamlined using the system 100 and corresponding navigation method. The user 107 selects options from up to five (or more, if desired) columns, for example, in a familiar left-to-right path to value a multitude of fields associated with the user's selections. The user 107 may also look at the data he has previously valued to compare it to other values, edit the data, or view a running history of values. The system 100 proactively assesses the next potential values aiding the user in quick selection, and eliminates costly mistakes or invalid selections. The system 100 also incorporates visual navigation using the display images 120 to further simplify the capture of data. Data sent to the display processor 118 quickly and easily appears in the display image 120 of the user interface 102, without interrupting the user's workflow. A navigation grid 212 (shown in FIGS. 2-6) enables the user 107 to view the captured data in a variety of display images 120 to aid in evaluating trends in the data.

The system 100 provides ease-of-use in navigating and valuing a multi-dimensional data set by presenting the options for navigation in a columnar layout where the possible combinations are quickly visible. The system 100 separates the navigation into new values, presentation of previously valued data, and analysis of captured data in three distinct views, thereby simplifying the workflow of the user 107.

The system 100 does not require users to revalue the same data repeatedly as the known tabular pop-up type of electronic documentation system. The user simply selects from the columns the values he wishes to value.

Unlike the known tree structure type of electronic documentation system that can hide much of the data forcing the user to search for the data the user 107 wishes to value, the system 100 displays the navigation on a single page, with no extraneous navigation such as expanding and collapsing branches of the known tree structure. The single page advantageously displays the data in a single composite display image 120, permitting the user to select their values with no additional selections (e.g., mouse clicks).

Unlike the known paper documentation model, the system 100 permits the user 107 to trend the captured data for further analysis. Further, the single composite display image 120 of the system 100 significantly decreases the amount of space required to display the same information that was displayed on paper documentation.

With general reference to FIG. 2, the system 100 is designed to allow multiple tiers (i.e., columns) (e.g., two columns or more) of data navigation with multiple rows (e.g., 10) of data, per tier, visible together. For example, five columns and ten rows provide “soft barriers” as the user 107 may scroll down the rows to an infinite number of rows. Practically, three columns provides significant advantages, but any number of columns, including one or two columns or more than three columns, may be used. Hence, the system 100 provides the user 107 with a multitude of possible combinations, for example, (e.g. 9,765,625 combinations), without scrolling or clicking to another page. The system 100 advantageously provides scalability for complex data capture.

The system 100 also incorporates predictive navigation meaning that the system 100 proactively enables/disables future navigation options, based on the user's 107 previous selections, thereby eliminating user error and greatly reducing time spent navigating the values.

In particular, the system 100 provides an electronic form 142. The display processor 118 provides the display image 120 enabling the user 107 to perform a hierarchically ordered selection of a first parameter 132, a second parameter 134, and a third parameter 136. A parameter may otherwise called an attribute, characteristic, aspect, feature, etc. The second parameter 134 is from a set of parameters associated with the selected first parameter 132. The third parameter 136 is from a set of parameters associated with the selected second parameter 134. FIGS. 2-6 represent the three parameters and the sets of parameters by reference number 211.

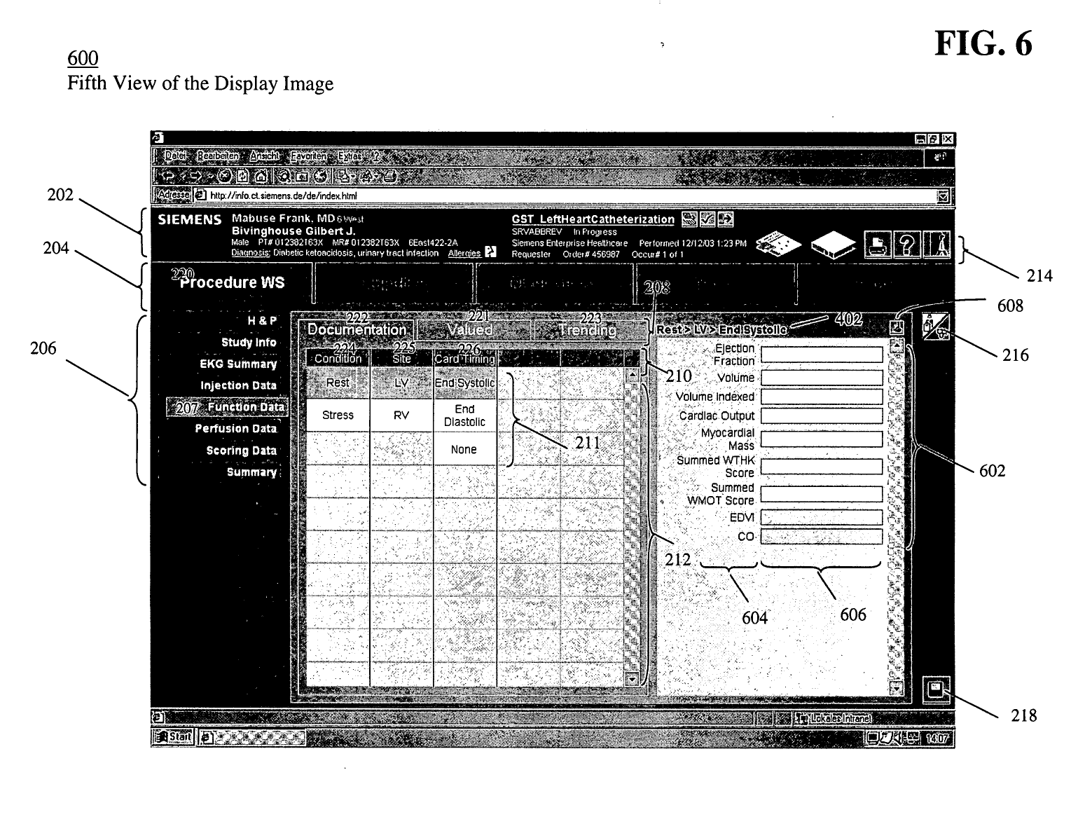

At least one repository 106 contains data, representing multiple data fields 140, for display in a form 142, and associates particular data fields 144 with a particular form 146 and a particular ordered selection of parameters 148. The form processor 122 generates data, representing a particular form 146, including particular data fields 144 derived from the repository 106 in response to user selection of the first 132, second 134, and third parameters 136. FIG. 6 generally represents the form 142 as reference number 602.

The display image 120 enables the user 107 to perform a hierarchically ordered selection of the first parameter 132 from a first image segment, the second parameter 134 from a second image segment, substantially adjacent to the first segment, and the third parameter 136 from a third image segment substantially adjacent to the second segment. For example, the first, second and third image segments are one or more of the following: columns and rows, in the display image 120, as shown in FIGS. 2-6.

The display image 120 is a single composite image, as shown in FIGS. 2-6, enabling the user to perform a hierarchically ordered selection of parameters and presenting the particular form provided by the form processor 122. The parameters are associated with a medical data acquisition process in a healthcare enterprise, and the particular form 146 supports medical data acquisition for a patient.

FIGS. 2-6 illustrate various views 200-600, respectively, of the same display image 120 generated by the system 100, as shown in FIG. 1. FIGS. 2-6 illustrate examples of an implementation of the system 100, as many variations of layout, description, and function of the display image 120 is possible.

FIGS. 2-6 represent a process or a method for the user 107 to navigate through complex data forms using the techniques described herein to select and enter data. The system 100 permits the user 107 to select and enter vast amounts of data quickly and efficiently, for example, during a procedure. The following text provides a description of the user's 107 interaction 111 with the system 100, via the various views 200-600 of the same display image 120 generated by the system 100. The various views 200-600 of the same display image 120 may also be referred to as a form, documentation, report, etc.

If the user 107 intends to value the same form and same field in the form multiple times, the system 100 may provide an enterprise setting for that form, which returns a blank version of that form anytime an appropriate combination is created in the navigation grid 212. In this case, a method to see the previously entered data is in the valued tab. In the valued tab, several entries for the same form and fields appear, if the system 100 has saved multiple data for the same form. The user 107 brings up a new form from the navigation grid 212 by selecting the cell in the terminal column again, which causes the system 100 to request the form from the server and cache the previously entered data.

The user 107 interacts 111 with various views 200-600 of the same display image 120 from left-to-right, for example. However, any direction of navigation or interaction may be employed, such as, for example, right-to-left, top-to-bottom, bottom-to-top, wherein the direction selection of the columns in the grid 212 matching the direction/location in the form 602. The flow of selecting parameters in the documentation grid 212 is left to right, for example. If the user 107 employs columns 224-226 and values column 224, the user 107 needs to know the value of the parameter in column 225. After valuing column 225, the user 107 needs to know the value of the parameter in column 226. If the user 107 selects a different value of the parameter in column 224, columns 225 and 226 (i.e., the subsequent or remaining columns) are reset based on the new selection.

The system 100 disables columns of the various views 200-600 of the same display image 120, until the appropriate time. Entire columns 225 and 226 of data may be disabled until the user 107 selects a parameter in a column to the left of the disabled column. The system 100 interprets the parameter the user 107 selected in a given column, and enables a column where applicable.

The system 100 permits an entire column to remain disabled when the user 107 selects a parameter, while another subsequent column becomes enabled. For example, if the grid has three columns 224-226, at initialization the system 100 enables column 224 and disables columns 225 and 226. Upon the user 107 selecting a parameter from column 224, column 225 may remain disabled as none of the options apply to the parameter. However, the system 100 enables column 226 because the context of the parameter relates to column 226 and not column 225.

The system 100 refreshes the various views 200-600 of the same display image 120, at an appropriate time, such as, for example, automatically, periodically, after each parameter selection, after manual selection of the refresh function 608, etc. When the user 100 selects various parameters and navigates across the columns of data, the user 107 reaches a point at which no further columns to the right are enabled. When there are no further options for the user 107 to select, the documentation grid 212 automatically refreshes, without user interaction.

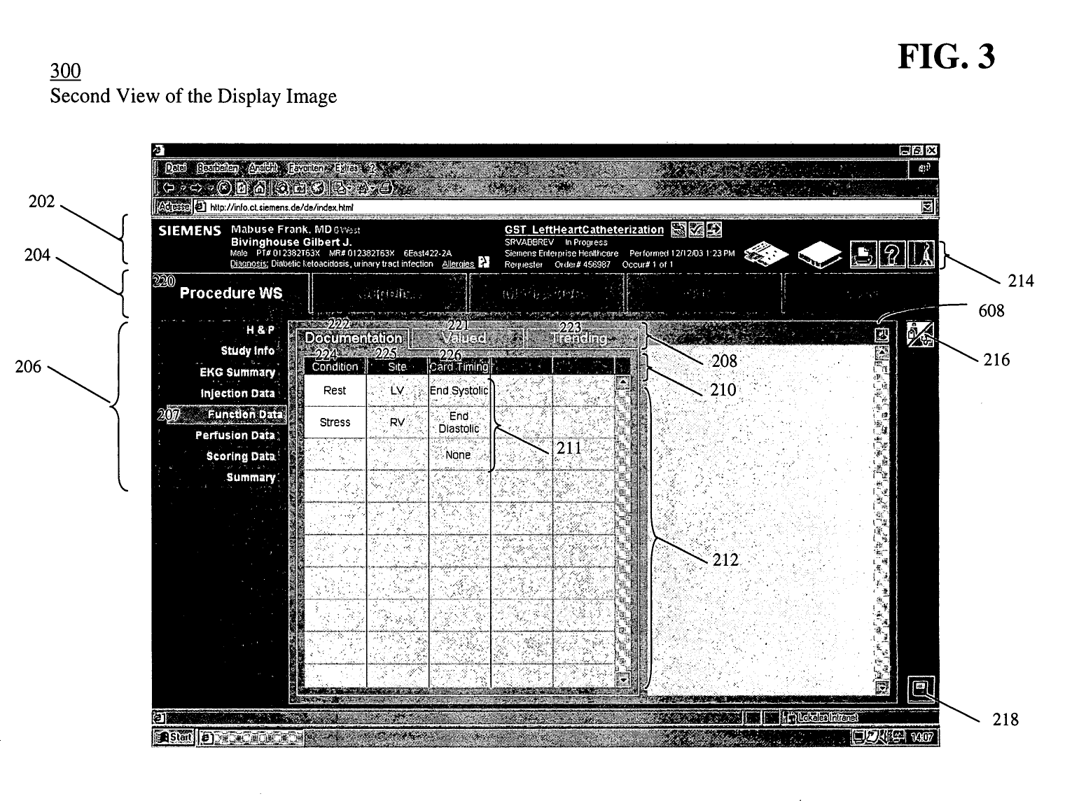

With particular reference to FIG. 3, the system 100 defaults the complex documentation grid 212 to three columns, for example, with various amounts of data in each column 224, 225, and 226. The user 107 has not yet selected a parameter in the “Condition” column 224 (e.g., no selection is shown, since both items are shown as white boxes), so the system 100 disables the parameters in both the “Site” column 225 and the “Card Timing” column 226 (e.g., disabled parameters are shown as shaded boxes).

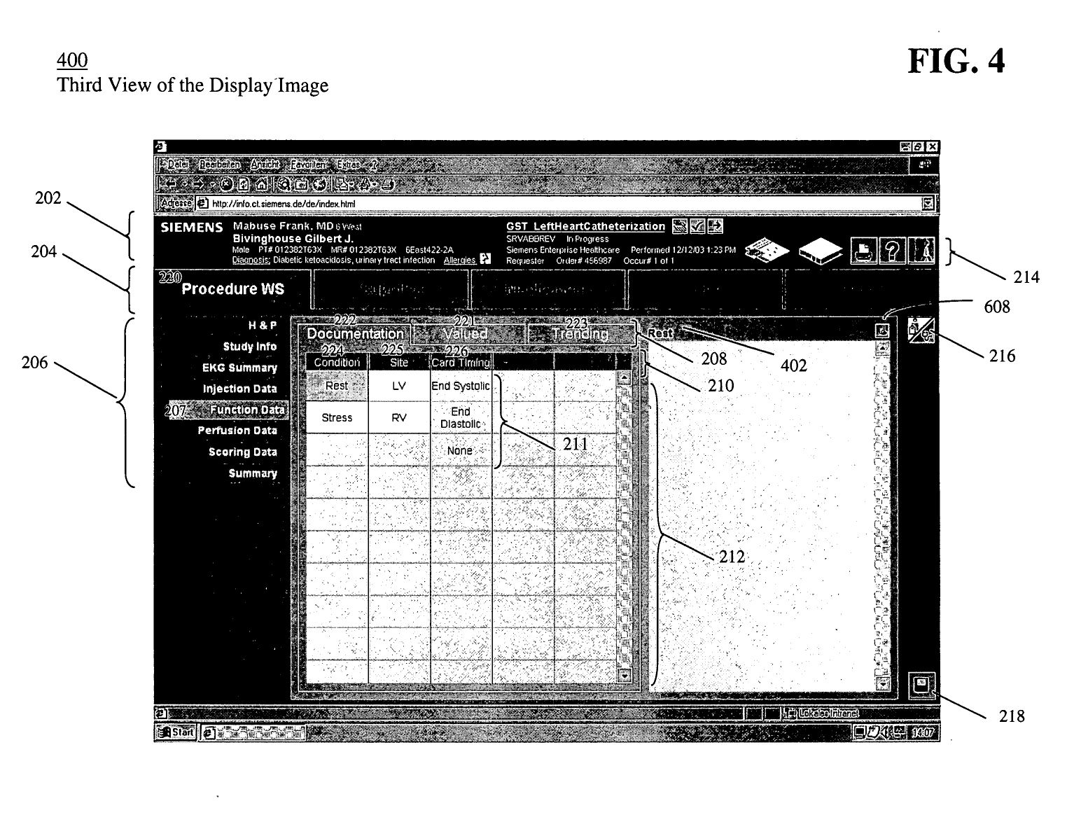

With particular reference to FIG. 4, the user 107 selects the “Rest” parameter in the “Condition” column 224 (e.g., a selection is shown as a shaded box). Based on this selection, the system 100 determines that both the “LV” and “RV” parameters in the “Site” column 225 may be combined with the “Rest” and the “Condition” parameters in column 224. Therefore, the system 100 enables both of these parameters (e.g., available selections now shown as white boxes).

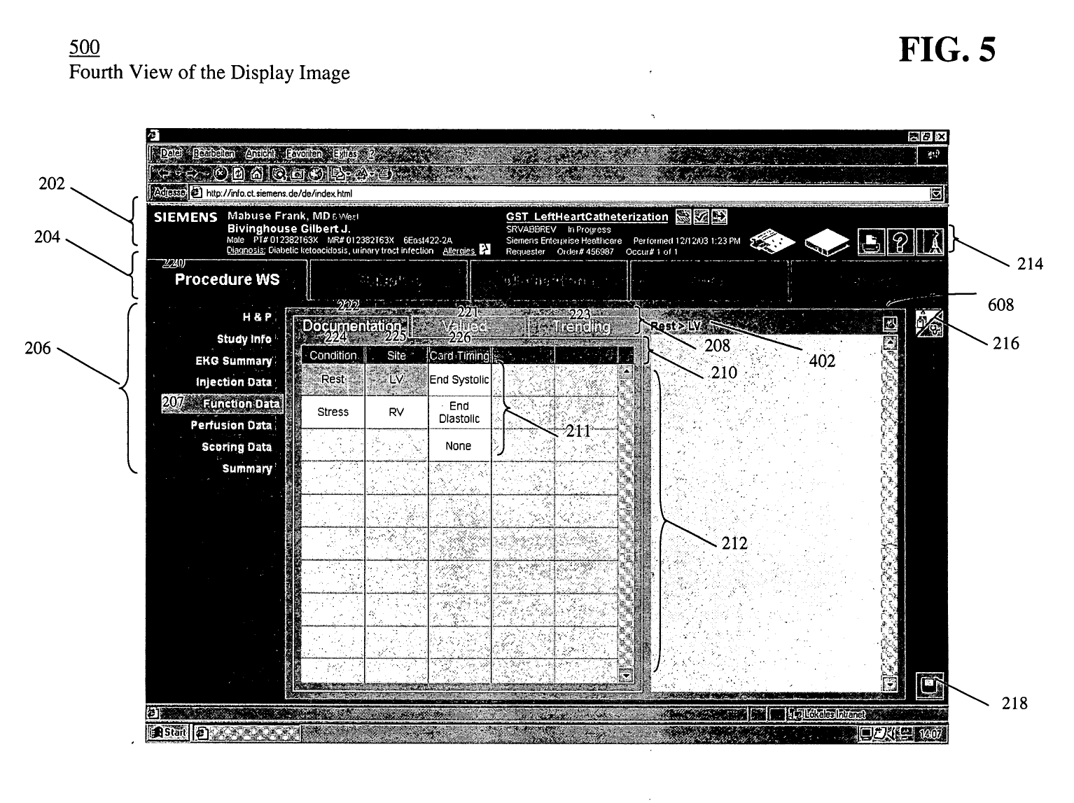

With particular reference to FIG. 5, the user 107 selects the “LV” parameter in the “Site” column (e.g., selected parameter now shown as a shaded box). Again, the system 100 determines possible parameters in the “Card Timing” column 226 based on the selections of parameters “Rest” and “LV” in the “Site” column 225. Therefore, the system 100 enables the entire “Card Timing” column 226 (e.g., available selections now shown as white boxes).

With particular reference to FIG. 6, the user 107 selects the “End Systolic” parameter in the “Card Timing” column 226, thus completing an appropriate combination of parameters in columns 224-226 to generate a form 602 on the right side of the screen. The user 107 does not need to refresh the right side of the screen at this time. The form 602 automatically refreshes after the user 107 has selected a parameter in the right most column (e.g. the “Card Timing” column 226). If the user 107 wishes to invoke a form 602 based only on selections in the first two columns 224 and 225, the user 107 needs to select the “None” parameter in the “Card Timing” column 226 to notify the system 100 of the user's intention. Upon selecting the “None” parameter, the right side of the display image 120 displays the appropriate form 602 based on the user's selection of parameters in the first two columns 224 and 225.

The following text provides a description of various aspects shown in the various views 200-600 of the same display image 120 in FIGS. 2-6. The aspects generally include, for example, data fields and controls. In particular, the aspects include, as shown in FIGS. 2-6, patient information 202, process tabs 204, adaptable chapters 206 (including “function data” 207), complex documentation tabs 208, a documentation grid 212, column headers 210, a data select function 211, a graphic select function, represented by the documentation grid 212, a plus function 228, a technician/nurse-physician toggle function 216, a save function 218. FIGS. 4-6 show parameter “breadcrumbs” 402 (i.e., portions of report information). FIG. 6 shows data fields 602, data form field labels 604, data form fields 606, and a refresh function 608, which is also shown in FIGS. 2-5. Another aspect that may be shown, but is not shown is generated text. The patient information 202 provides general and/or specific information about a patient corresponding to the documentation. The patient information 202 includes, for example, the patient's name, the patient's doctor's name, the patient's gender, the patient's identification, the patient's medical record identification, the patient's location in the facility, the patient's diagnosis, the medical process (e.g., test, lab, procedure, etc.) corresponding to the documentation, the date and/or time of the medical process, the party requesting (i.e., ordering) the medical process, the order number, and the number of medical processes ordered.

The process tabs 204 provide various types of goods or services that may be documented. The goods or services include, for example, procedures 220 (e.g., selected in FIGS. 2-6), supplies, medications, notes, and reports using the system 100. For example, the system 100 assists the user 107 with automatic reporting of medical procedures when the user 107 selects the procedure tab 220. In another example, the system 100 assists the user 107 with automatic reporting of medical medications (e.g., prescriptions, instructions, side effects, etc.) when the user 107 selects the medications tab.

The adaptable chapters (e.g., otherwise referred to as tabs) 206 provide various specific procedures that may be documented. Specific procedures include, for example, H & P, study info, EKG summary, injection data, function data (e.g., selected in FIGS. 2-6) 207, perfusion data, scoring data, and summary.

The system 100 provides complex documentation workflow as a chapter type for adaptable forms. In FIGS. 2-6, for example, the system 100 displays complex documentation as chapter 5 (i.e., the fifth tab labeled “Function Data”) of the procedures tab 220. The system 100 may employ multiple adaptable chapters with complex documentation.

The system 100 displays one complex documentation view, for example, on a single adaptable chapter. On any chapter with a complex documentation view, the system 100 does not display other types of adaptable forms. There may be multiple complex documentation views with each on a different adaptable chapter. An element may appear in multiple complex documentation views, and, therefore, may be valued from multiple locations in the documentation. In this case, the system 100 values a single entry in the documentation, corresponding to a database, as the multiple representations of the same data element correlating to a single data element in the database. The system 100 selects the first chapter upon initialization. The system 100 refreshes the display image 120 at the appropriate time.

Under the complex documentation tabs 208, the “documentation” tab 222 allows the user to select a path from predefined parameters to value data in the “data fields” 606 on the right. The “valued” tab 221 acts as both a history, and a “to do” list of linked parameters. The “trending” tab 223 allows the user 107 to compare valued data with various forms of future data. The system 100 selects the documentation tab 222 in the initial state. The system 100 refreshes the display image 120 upon selection of a tab 221-223.

Under the documentation tab 222, the system 100 displays the documentation grid 212. The system 100 defines the number of column headers 210 and the number of parameters 211. For example, the system 100 defines the number of columns to be a maximum of five. The user 107 may scroll down a vertical scroll bar to display more parameters, if needed.

The column headers 224-226 identify the type of parameter that the system 100 displays in the particular columns. The system 100 does not permit the user 107 to scroll across the columns 224-226 when the documentation grid 212 displays the column information in the three columns 224-226 at the same time. If more columns are available that can be viewed at the same time, then the system 100 may permit the user 107 to scroll across the columns 224-226. The system 100 displays appropriate text for the column headers 224-226, based on the particular process.

The data select function is a selectable parameter cell or box 211, for the corresponding column 224-226, having both selected and unselected states. The user 107 selects a parameter cell 211 by selecting (e.g., clicking) the name of the parameter cell 211. Hence, each parameter cell 211 provides a selectable button. The initial state of the button is unselected. After a user selects a particular parameter cell 211, the system 100 highlights the particular parameter cell 211 and the subsequent column of cells becomes enabled (e.g., indicated by highlighting the subsequent column of cells). Resposive to a connection of the parameter cells 211, the system 100 prompts a data field 602 to appear on the right side of the display image 120, as shown in FIG. 6.

The graphic select function represents a selectable parameter cell 211 for the next corresponding column 225 or 226 when the user 107 selects the parameter cell 211. For example, when the user 107 selects the “Rest” parameter cell under the “Condition” column, as shown in FIG. 4, the system highlights “LV” and “RV” parameter cells under the “Site” column 225 (e.g., by lightening the boxes).

The system 100 provides a plus function 228 (e.g., button or cell), as shown in FIG. 2, at the bottom row of each column 224-226. The system enables the plus buttons 228, unless the available parameters are currently displayed in the column. For example, consider when there are ten parameters 211 for the “Site” column 225, and the system 100 currently displays five parameters 211 in the “Site” column 225. The system 100 causes the plus button 225 to remain enabled, until the system 100 displays ten parameters 211 in the column, at which time the system 100 disables (e.g., hides or shades) the plus function 225. When the user 107 selects the plus function 228, the system 100 displays a parameter in the same column below the displayed data.

The system 100 displays the data field 602, as shown in FIG. 6, under each of the documentation tab 222 and the valued tab 221. The system 100 populates the data field 602 with appropriate form fields 604 and 606 based on the selected parameters 211 in the grid 212 under each of the documentation tab 222 and the valued tab 221. In the data field 602, the left column of the data field 602 displays data field labels 604, and the right column of the data field 602 displays an appropriate corresponding data entry field 606 (e.g., a combo box, a data field, etc.) for each data field label 604. The system 100 determines the data field labels 604 (e.g., text and length) and the corresponding data entry fields 606 (e.g., alpha, numeric, alpha-numeric, etc.) corresponding to a specific path of selected parameters 211 from the various columns under each of the documentation tab 222 and the valued tab 221. The system 100 refreshes the data field 602 at the appropriate time, as explained hereinabove. The system 100 permits a user 107 to vertically scroll through the data field 602, if needed.

The system 100 displays the parameter breadcrumbs 402, as shown in FIGS. 4-6, over the data field 602. The parameter breadcrumbs 402 show the user 107 what data set the user 107 is valuing in the data field 602, after the user 107 selects the appropriate parameters 211 in the grid 212. The system 100 displays text for the parameter breadcrumbs 402 that correspond to the selected parameters. For example, in FIG. 4, the parameter breadcrumbs 402 include the text “Rest” corresponding to the selected parameter cell for “Rest” in the “Condition” column 224. The system 100 refreshes the data field 602 responsive to the user 107 selecting the refresh function 608, as shown in FIG. 6, or automatically, as preferred.

The system 100 generates report text (not shown in the figures) by converting the data field 602 values into logical, readable sentences in a read only format. The system 100 permits the user 107 the option to display or not display the generated text field on the complex documentation in the display image 120. An example of a sentence is “The patient has a volume of 30 mg during the end systolic cardiac timing of the left ventricle while at rest.”

The technician/nurse-physician toggle function (e.g., button) 216 enables the user to switch between two different views of the procedure worksheet tab. The two different views correspond to the nurse/tech data view (i.e., when the top left triangle in the button 216 is selected) and the physician data view (i.e., bottom right triangle in the button 216 is selected). The system 100 disables the entire button 216 when a) the tech/nurse data has not been signed and the healthcare enterprise does not allow the user 107 to toggle between the two views when the data is not signed, or b) the tech/nurse is not allowed to see the physician data. The system 100 displays a selected upper left triangle (i.e., the nurse/tech data view) and a non-selected lower right triangle (i.e., the physician data view) of the button 216 when the user 107 has a) signed the tech/nurse data, or b) the healthcare enterprise allows the tech/nurse to toggle between the two views. The system 100 may also display a non-selected upper left triangle (i.e., the nurse/tech data view) and a selected lower right triangle (i.e., the physician data view) of the button 216. The entire button 216 is selectable (i.e., clickable) by the user 107 to switch between the two views. The procedure worksheet has hidden/disabled fields which become visible/enabled or hidden/disabled when switching between the views.

The save function (button) 218 saves the data.

The system 100 also provides other general functions (e.g., buttons) 214, such as print, help, etc. for the user 107.

The system 100 supports simplified navigation using table driven values and decisions. Users 107 are able to design complex combination systems that mix manual and automated styles. By contrast, the prior known implementations are awkward and cumbersome and fail to provide the features and flexibility provided by the system 100.

The system 100 is applicable to any application where multi-dimensional data needs to be valued in a restricted display space and where speed of data valuation is important. The system 100 is also applicable to any software platform.

The system 100 provides users with a simple electronic navigation method to choose multi-dimensional data with no more than five clicks, for example, that can value over nine million combinations, for example. The system 100 provides an easy-to-learn and easy-to-use user interface eliminates steep user learning curves, especially for new and occasional users. The system 100 facilitates rapid adoption of new systems.

The system 100 reduces complexity and cumbersome navigation of clinical systems, such as critical care units, emergency departments, and oncology diagnostic and therapeutic departments, where complex diagnosis and treatment management techniques are routinely performed. The system 100 optimizes decision selections and keeps the clutter of multiple potentially related selections from confusing the primary decision selection process. The system 100 is ideal for clinicians in critical care settings where they are easily distracted by multiple events and interruptions. The system 100 aligns the decision process to the demands with a solution that supports rapid and instinctive decisions. Such a simplified user interface becomes an important prerequisite for clinical applications.

Hence, while the present invention has been described with reference to various illustrative examples thereof, it is not intended that the present invention be limited to these specific examples. Those skilled in the art will recognize that variations, modifications, and combinations of the disclosed subject matter can be made, without departing from the spirit and scope of the present invention, as set forth in the appended claims.

What is claimed is:

1. A user interface system for providing an electronic form, comprising:
a display processor for providing a display image enabling a user to perform a hierarchically ordered selection of,
a first parameter and
a second parameter from a set of parameters associated with the selected first parameter;
at least one repository containing data representing a plurality of data fields for display in a form and associating particular data fields with a particular form and a particular ordered selection of parameters; and
a form processor for generating data representing a particular form including particular data fields derived from the repository and initiating generation of data representing a display image including the particular form, in response to user selection of the first and second parameters.

2. A system according to claim 1, wherein
the parameters are associated with a medical data acquisition process and the particular form supports medical data acquisition for a patient.

3. A system according to claim 1, wherein
the display image is a single composite image enabling the user to perform a hierarchically ordered selection of parameters and presenting the particular form.

4. A user interface system for providing an electronic form, comprising:
a display processor for providing a display image enabling a user to perform a hierarchically ordered selection of,
a first parameter,
a second parameter from a set of parameters associated with the selected first parameter and
a third parameter from a set of parameters associated with the selected second parameter,
at least one repository containing data representing a plurality of data fields for display in a form and associating particular data fields with a particular form and a particular ordered selection of parameters; and
a form processor for generating data representing a particular form including particular data fields derived from the repository in response to user selection of the first, second and third parameters.

5. A system according to claim 4, wherein
the display image enables a user to perform a hierarchically ordered selection of,
the first parameter from a first image segment,
the second parameter from a second image segment substantially adjacent to the first segment and
the third parameter from a third image segment substantially adjacent to the second segment.

6. A system according to claim 5, wherein
the first, second and third image segments are at least one of, (a) columns and (b) rows, in the display image.

7. A system according to claim 4, wherein
the display image is a single composite image enabling the user to perform a hierarchically ordered selection of parameters and presenting the particular form provided by the form processor.

8. A system according to claim 4, wherein
the parameters are associated with a medical data acquisition process and the particular form supports medical data acquisition for a patient.

9. A system comprising:
a display processor for generating display image data;
a display to provide a display image responsive to receiving the display image data, wherein the display includes:
a navigation area including:
a first set of parameters located in a first part of the navigation area; and
a second set of parameters located in a second part of the navigation area;
a data input device, coupled to the display processor, for receiving data from a user, wherein the data input device receives data from the user representing a selection of:
a first parameter from the first set of parameters; and
a second parameter from the second set of parameters, wherein the second parameter is associated with the first parameter,
at least one repository for storing data, representing a plurality of data fields, for presentation by the display in an electronic form and for associating particular data fields with a particular electronic form and a particular ordered selection of parameters; and
a form processor for generating data, representing a particular electronic form including particular data fields derived from the repository, and for initiating generation of data, representing a display image, including the particular form, in response to user selection of the first and second parameters.

10. A system according to claim 9, wherein
the first and second set of parameters are associated with a medical data acquisition process and the particular electronic form supports medical data acquisition for a patient involved with the medical data acquisition process.

11. A system according to claim 9, wherein
the display image is a single composite image enabling the user to perform a hierarchically ordered selection of parameters and presenting the particular electronic form.

12. A system according to claim 9, wherein
the first set of parameters, located in the first part of the navigation area, are located substantially adjacent to the second set of parameters, located in the second part of the navigation area.

13. A system according to claim 9, wherein
the first set of parameters are arranged in at least one of rows and columns in the first part of the navigation area; and
the second set of parameters are arranged in at least one of rows and columns in the second part of the navigation area.

14. A system according to claim 9, wherein
a processor for translating the data, representing a particular electronic form, into at least one logical, understandable combination of words.

15. A system according to claim 9, wherein
the data input device receives data from the user for input into at least one of the data fields for presentation by the display in the electronic form.
